(19) United States
(12) Patent Application Publication
(10) Pub. No.: US 2023/0264727 A1
(43) Pub. Date: Aug. 24, 2023

(54) SECURING MECHANISM FOR A PORTABLE POWER SUPPLY BOX

(71) Applicant: MILWAUKEE ELECTRIC TOOL CORPORATION, Brookfield, WI (US)

(72) Inventors: Megan L. Korbel, Wauwatosa, WI (US); Nelson C. Arias Rotunno, Pewaukee, WI (US); Phillip R. Nensel, Wauconda, IL (US); Kyle J. Radovich, West Bend, WI (US)

(21) Appl. No.: 18/171,572

(22) Filed: Feb. 20, 2023

Related U.S. Application Data
(60) Provisional application No. 63/313,146, filed on Feb. 23, 2022.

(51) Int. Cl. B62B 1/10; H02J 7/00; H02B 1/46; B62B 1/00; B62B 5/04; B62B 5/06

(52) U.S. Cl. CPC B62B 1/10; H02J 7/0042; H02B 1/46; B62B 1/008; B62B 5/04; B62B 5/067; B62B 2005/0471

(57) ABSTRACT

A portable power source is moveable over a support surface. The portable power source has a power supply, a frame at least partially surrounding the power supply, at least one wheel, handle having a user engagement member a and a clamping mechanism. The clamping mechanism moves from a first position to a second position. The clamping mechanism stops the wheel in the first position and allows the rotation of the wheel in the second position.

### CROSS-REFERENCE TO RELATED APPLICATIONS

This application claims priority to prior-filed, co-pending U.S. Provisional Patent Application No. 63/313,146, filed on Feb. 23, 2022, the entire contents of which are incorporated herein by reference.

### FIELD

The present disclosure relates to a portable power supply box. More particularly, the present disclosure relates to a securing member that is attached to a portable power supply box to prevent the portable power supply box from unintentional rolling or unintentional rotating.

### BACKGROUND

Frequently, workers have tools that need to be plugged into a power supply box in order for the tools to be operable. To allow the workers to work in a variety of locations (e.g., in parking garage, on a hill, or on a handicap ramp) the power supply box may be portable and include wheels that allow the user to easily transport the power supply box. Many times, the most convenient place to work is on a slope and not on a flat ground. If not properly secured, the power supply box may start rolling down the hill. The unintentional rolling or rotating can cause an inconvenience and a safety hazard to the worker. There is a need for a securing member to prevent the power supply box from unintentionally rolling.

Worksites can be very expansive. Many times, workers have to change locations and need to carry all of their equipment (e.g., chargers, tools, etc.) with them. Therefore, it is beneficial for the securing to be compact and light in order to not add extra weight to the power supply box so that the user may still be able to easily transport the power supply box.

Additionally, worksites can have a variety of ground conditions. The hills or ramps may have different slope angles. The ground may also be a smooth surface, or it may be a loose ground material (e.g., gravel). Therefore, it is beneficial that the securing member is adaptable so that it works on a variety of surfaces and slopes.

Lastly, it is beneficial that the securing member is easy to activate and to disable. Frequently, workers have a limited amount of time at the worksite, so they do not want to spend a long time securing the power supply box. Other times, the workers may be carrying other equipment and will need to be able to activate the securing member with their feet.

Some embodiments of the present disclosure take these three desired features into account and balance them. One or more arrangements and forms of the securing member is sought herein to provide an optimization of portability, adaptability, and convenience.

### SUMMARY

The invention provides, in one aspect, a portable power source moveable over a support surface. The portable power source comprises a power supply, a frame at least partially surrounding the power supply, at least one wheel, a handle, and a clamping mechanism that moves from a first position to a second position. The wheel is attached to the frame by an axle. The handle has a user engagement portion and at least one upright member. The clamping mechanism prevents rotation of the wheel in the first position and allows the rotation of the wheel in the second position.

The invention provides, in another aspect, a portable power source moveable over a support surface. The portable power source comprises a power supply, a frame at least partially surrounding the power supply, at least one wheel, a handle, and a ground engagement member attached to the frame. The handle has a user engagement portion and at least one upright member. The ground engagement member is configured to pivot between an engaged position and a disengaged position. The ground engagement member is extended from the frame to contact the support surface in the engaged position.

The invention provides, in still another aspect, a portable power source moveable over a support surface. The portable power source comprises a power supply, a frame at least partially surrounding the power supply, at least one wheel, and a handle. The handle has a user engagement portion and at least one upright member. The upright member is slidable relative to the frame. The upright member is slidable into a locking position. The locking position has an end of the upright member, opposite the user engagement portion, extending past the wheel to engage the support surface.

### BRIEF DESCRIPTION OF THE DRAWINGS

FIG. 1 is a side view of a portable power supply box, according to embodiments disclosed herein.

FIGS. 2A-2B are front views of the power supply box of FIG. 1 with a disk lock in the unlocked and locked positions, according to embodiments disclosed herein.

FIGS. 3A-3B are front views of the power supply box of FIG. 1 with a rim lock in the unlocked and locked positions, according to embodiments disclosed herein.

FIGS. 4A-4B are front views of a locking mechanism to be used with the securing members illustrated in FIGS. 2A-2B and FIGS. 3A-3B, according to embodiments disclosed herein.

FIGS. 5A-5C are front views of the power supply box of FIG. 1 with a pin lock in the unlocked and locked positions, according to embodiments disclosed herein.

FIGS. 6A-6B are front views of the power supply box of FIG. 1 with a wheel chock assembly in the unlocked and closed positions, according to embodiments disclosed herein.

FIGS. 7A-7B are front views of the power supply box of FIG. 1 with a stop rod assembly in the unlocked and locked positions, according to embodiments disclosed herein.

FIGS. 8A-8B are front views of the power supply box of FIG. 1 with a kickstand in the unlocked and locked positions, according to embodiments disclosed herein.

FIGS. 9A-9B are front views of the power supply box of FIG. 1 with a hinged kickstand in the unlocked and locked positions, according to embodiments disclosed herein.

FIGS. 10A-10B are front views of the power supply box of FIG. 1 with a spring supported kickstand in the unlocked and locked positions, according to embodiments disclosed herein.

FIGS. 11A-11B are front views of the power supply box of FIG. 1 with a telescoping kickstand in the unlocked and locked positions, according to embodiments disclosed herein.

FIG. 12 is a detailed view of the telescoping kickstand of FIGS. 11A-11B.

FIG. 13 is a front view of the power supply box of FIG. 1 with a rubber foot, according to embodiments disclosed herein.

FIG. 14 is a front view of the power supply box of FIG. 1 with a cam, according to embodiments disclosed herein.

FIGS. 15A-15B are side views of the power supply box of FIG. 1 with a collapsible handle in the unlocked and locked positions, according to embodiments disclosed herein.

FIG. 16 is a front view of the power supply box of FIG. 1 with a wheel block, according to embodiments disclosed herein.

FIG. 17 is a front view of the power supply box of FIG. 1 with an anchor, according to embodiments disclosed herein.

FIGS. 18A-18B are perspective views of a footpad trigger, according to embodiments disclosed herein.

Features and aspects of the disclosure will become apparent by consideration of the following detailed description and accompanying drawings.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

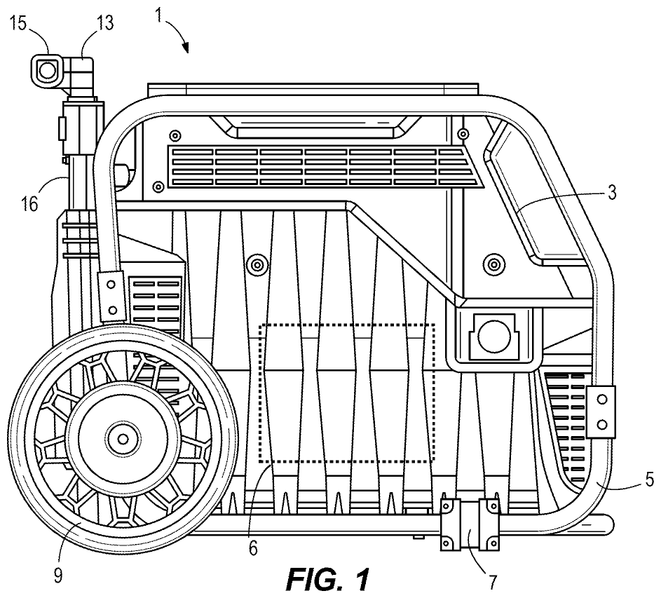

With reference to FIG. 1, an example of a portable power supply box 1, also known as a portable power source, is shown. The power source allows a user to plug in larger power tools to be able to operate them or charge multiple battery packs at a remote worksite. The power supply box 1 may include a large power source 6 (e.g., a battery) that can be used to supply power to the attached battery packs.

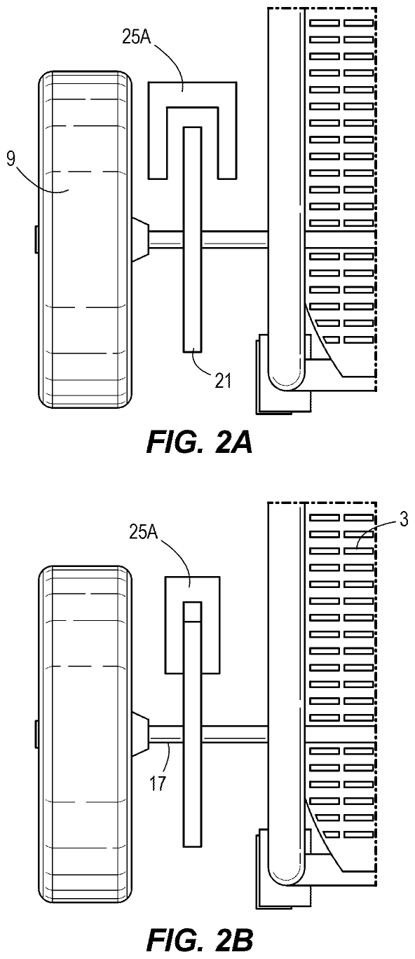

The frame of the power supply box 1 includes a housing 3 and a roll cage 5. The roll cage 5 may be disposed on the outside of the housing 3 of the power supply box 1 to help protect the power supply box 1 if the power supply box 1 tips. The power supply box 1 may also include a handle 13 coupled to the frame and at least one wheel 9 that allow a user to easily transport the power supply box 1 across the ground support surface (e.g., the support surface) to different worksites. In the illustrated embodiment, the handle 13 is a retractable handle that is slidable relative to the frame and the power supply box 1 has two wheels 9. The handle 13 includes a user engagement portion 15 and at least one upright member 16. Each wheel 9 is located adjacent the handle 13 and is attached to the power supply box 1 by an axle 17 (FIG. 2A). The axle 17 may define the rotational axis of the wheel 9. To help stabilize the power supply box 1, there may be a pair of feet 7 attached to the bottom of the roll cage 5. The pair of feet 7 may be opposite the wheel 9.

Turning to FIGS. 2A-2B, an embodiment of the power supply box 1 is shown with a disk lock assembly. The disk lock assembly includes a disk 21 and a clamping mechanism 25A. The disk 21 is coupled on the axle 17 of the wheel 9. The clamping mechanism is moveable between a clamped position (e.g., a first position) and a released position (e.g., a second position). In the released position (FIG. 2A), the clamping mechanism 25A is not engaged with the axle 17, and the axle 17 and wheel 9 can rotate freely. In the clamped position (FIG. 2B), the clamping mechanism 25A is engaged with the axle 17, and the axle 17 and the wheel 9 are prevented from rotating. The method of clamping (e.g., moving between the clamped and released positions) the clamping mechanism 25A to the axle 17 will be discussed below.

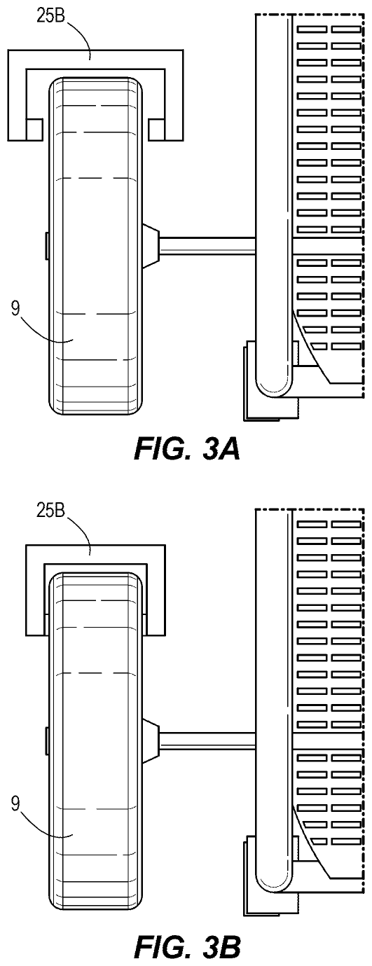

FIGS. 3A-3B show another embodiment of the power supply box 1 with a rim lock assembly. The rim lock assembly includes a clamping mechanism 25B that connects to the wheel 9. In the released position (FIG. 3A), the clamping mechanism 25B is not engaged with the wheel 9, and the wheel 9 can rotate freely. In the clamped position (FIG. 3B), the clamping mechanism 25B is inserted through the wheel 9 and prevents the wheel 9 from rotating. The method of clamping the clamping mechanism 25B to the wheel 9 will be discussed below.

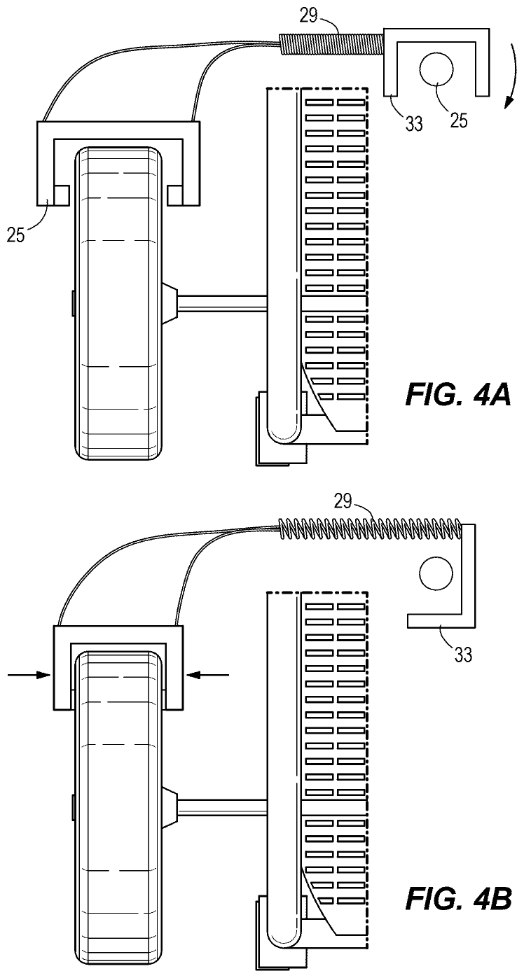

The clamping mechanism 25 for the first and second embodiments of the power supply box 1, shown in FIGS. 2A-3B, is illustrated in FIGS. 4A-4B. The clamping mechanism 25 includes two clips 33 (e.g., a first actuator and a second actuator) connected to the clamping mechanism. Each of the two clips 33 has an actuator spring 29. The two clips 33 are located on opposite sides of the clamping mechanism 25. In the release position (FIG. 4A), the two clips 33 are disposed on either side of the axle 17 or the wheel 9, and there is a gap between the two clips 33 and the axle 17 or the wheel 9. To move the clamping mechanism 25 into the clamped position (FIG. 4B), a user twists the two clips 33 downward until the two clips 33 make contact with each other, with the axle 17, or with the wheel 9. The actuator spring 29 stretches when the two clips 33 are twisted. The actuator spring 29 may bias the clamping mechanism 25 to the release position or the clamped position. In the illustrated embodiment, the actuator spring 29 biases the clamping mechanism to the release position. When the clamping mechanism 25 is in the clamped position, the wheel 9 is prevented from rotating, thus securing the power supply box 1.

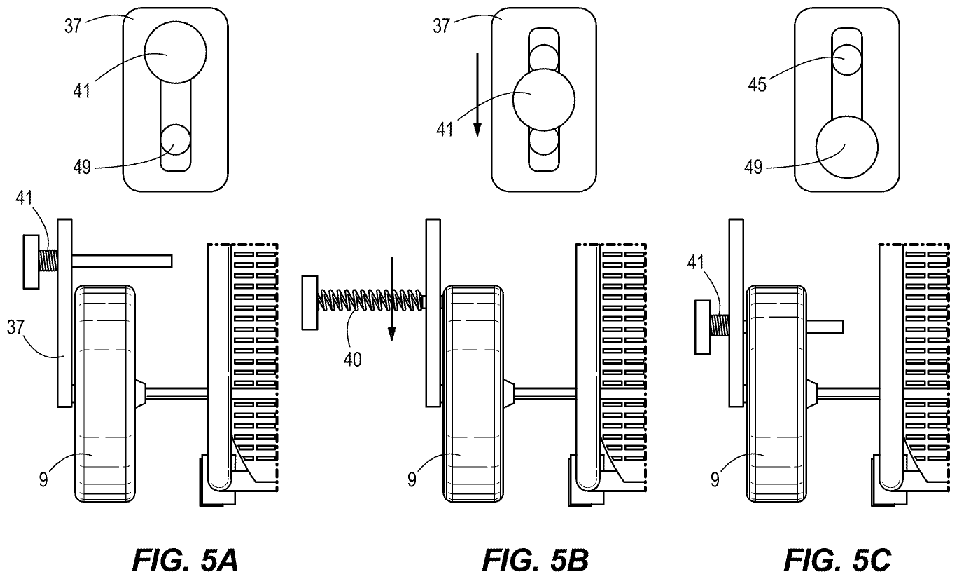

With reference to FIGS. 5A-5C, another embodiment of the power supply box 1 is shown with a pin lock assembly. The pin lock assembly includes a plate 37 and a pin 41 slidably coupled to the plate 37. The pin 41 moveable in a direction parallel to the rotational axis of the wheel and is configured to selectively engage the wheel. The pin 41 may include a handle and a spring 40. The spring 40 biases the handle of the pin 41 against the plate 37. The plate 37 may be coupled to the wheel 9 or frame in such a way that it extends beyond the wheel 9 but does not interfere with the rolling of the wheel 9. The plate 37 may have a first pin hole 45 disposed on the top of the plate 37 and a second pin hole 49 opposite the first pin hole 45 and adjacent the wheel 9. The first pin hole 45 and second pin hole 49 are configured to receive the pin 41.

In the unlocked position (FIG. 5A), the pin 41 is in the first pin hole 45 such that the pin 41 is not engaged with the wheel 9. To move the pin lock assembly to the locked position, the user pulls the pin 41 out of first pin hole 45 and inserts the pin 41 into the second pin hole 49. In the locked position (FIG. 5C), the pin 41 is in the second pin hole 49 and extends through the plate 37 and the wheel 9 to lock the wheel 9 such that the pin 41 prevents the wheel 9 from rotating. The plate 37 may include a securing mechanism (e.g., a tether), not shown, that secures the pin 41 to the plate 37 in such a way that the pin 41 can move but not be fully separated from the plate 37.

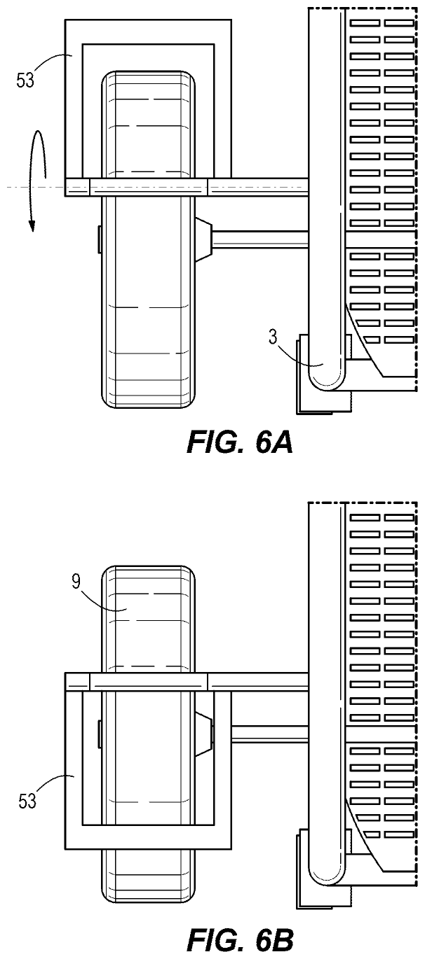

Yet another embodiment of the power supply box 1 is shown in FIGS. 6A-6B with a wheel chock assembly. The wheel chock assembly includes a square wheel chock 53. The wheel chock 53 may be pivotably disposed on the roll cage 5 or the housing 3. The wheel chock 53 is pivotable between a locked position and an unlocked position. In the unlocked position (FIG. 6A), the wheel chock 53 is not engaged with the wheel 9. To move the wheel chock 53 from the unlocked position to the locked position, the wheel chock 53 is flipped downward, towards the wheel 9. The wheel chock 53 rotates in a plane that is perpendicular to the rotational axis of the wheel 9. In the locked position (FIG. 6B) at least a portion of the wheel chock 53 may be engaged with the wheel 9 or may rest against the perimeter of the wheel 9, preventing the wheel 9 from rotating.

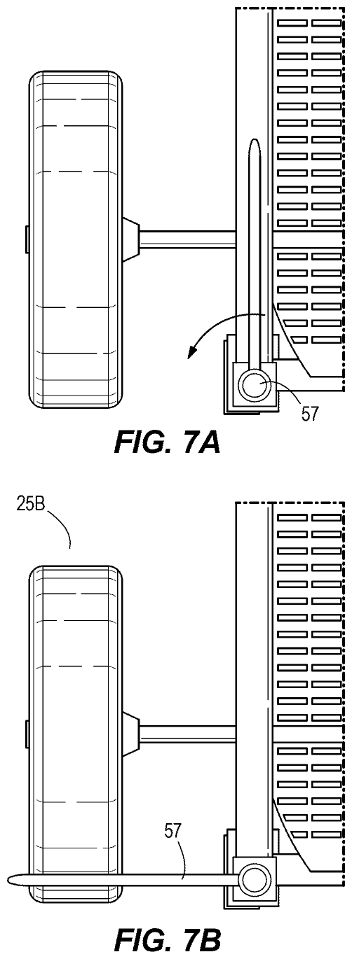

Turning to FIGS. 7A-7B, another embodiment of the power supply box 1 is shown with a stop rod assembly. The stop rod assembly may include a stop rod 57 that is pivotally attached to the roll cage 5 or the housing 3. In the unlocked position (FIG. 7A), the stop rod 57 is situated adjacent the roll cage 5, and the wheel 9 is not blocked. To move from the unlocked position to the locked position, the stop rod 57 is then rotated away from the roll cage 5. The stop rod 57 may rotate in a plane that is parallel to the rotational axis of the wheel 9. In order to clear the wheel 9, the stop rod 57 may be translated in a direction that is perpendicular to the plane of rotation before rotating the stop rod 57. Said another way, a section of the stop rod 57 may be retracted in the housing 3 or the roll cage 5, and in order to clear the wheel 9, the user extends the stop rod 57 in a direction out of the housing 3 or roll cage 5 before rotating the stop rod 57. In the locked position, the stop rod 57 may be engaged with the wheel 9 or may rest against the perimeter of the wheel 9, preventing the wheel 9 from rotating.

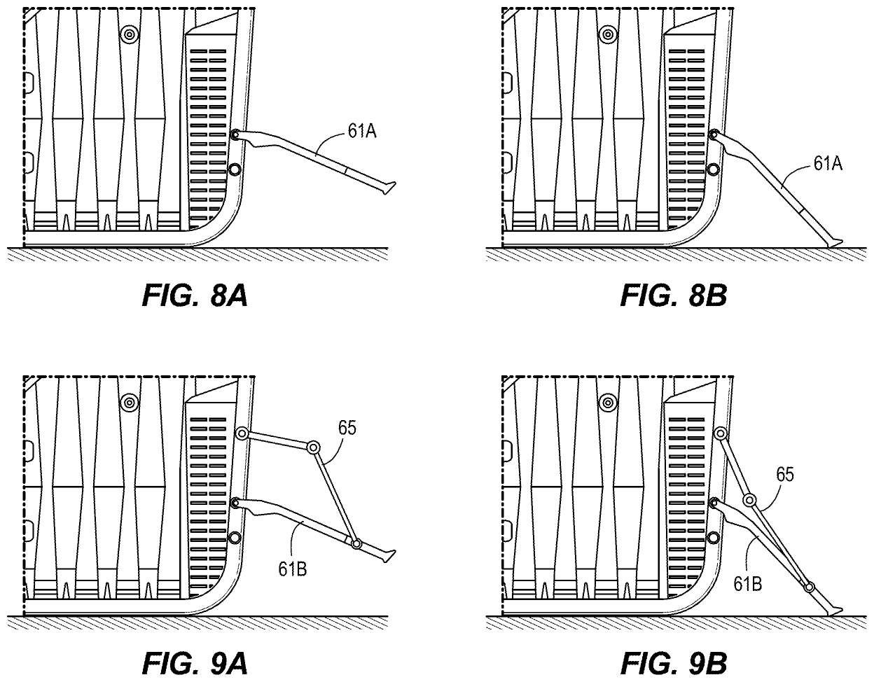

Another embodiment of the power supply box 1 that utilizes a kickstand 61A (e.g., a ground engagement member) is shown in FIGS. 8A-8B. The kickstand 61A may be pivotably attached to the of the housing 3 of the power supply box 1 or the roll cage 5. The kickstand 61A is pivotable between an engaged position and a disengaged position. In the disengaged position (FIG. 8A), the kickstand 61A is spaced from the ground. To move the kickstand 61A to the engaged position (FIG. 8B), the user folds down the kickstand 61A until the kickstand 61A is engaged with the ground. The kickstand 61A provides additional support to the power supply box 1 such that it is more difficult for the power supply box 1 to roll.

FIGS. 9A-9B show another embodiment of the power supply box 1 that utilizes a kickstand 61B. The kickstand 61B is similar to the kickstand 61A, however in order to provide additional support to the kickstand 61B, a hinged lever 65 is attached to the kickstand 61B. Both the kickstand 61B and the hinged lever 65 may be attached to the back of the housing 3 or the roll cage 5 of the power supply box 1. The hinged lever 65 and the kickstand 61B fold down from the back or side of the power supply box 1 until the kickstand 61B engages the ground. Once the kickstand 61B is engaged with the ground, the hinged lever 65 is fully extended such that the hinged lever 65 locks down into place. The hinged lever 65 provides extra strength to the kickstand 61B such that the power supply box 1 may be used on steeper hills.

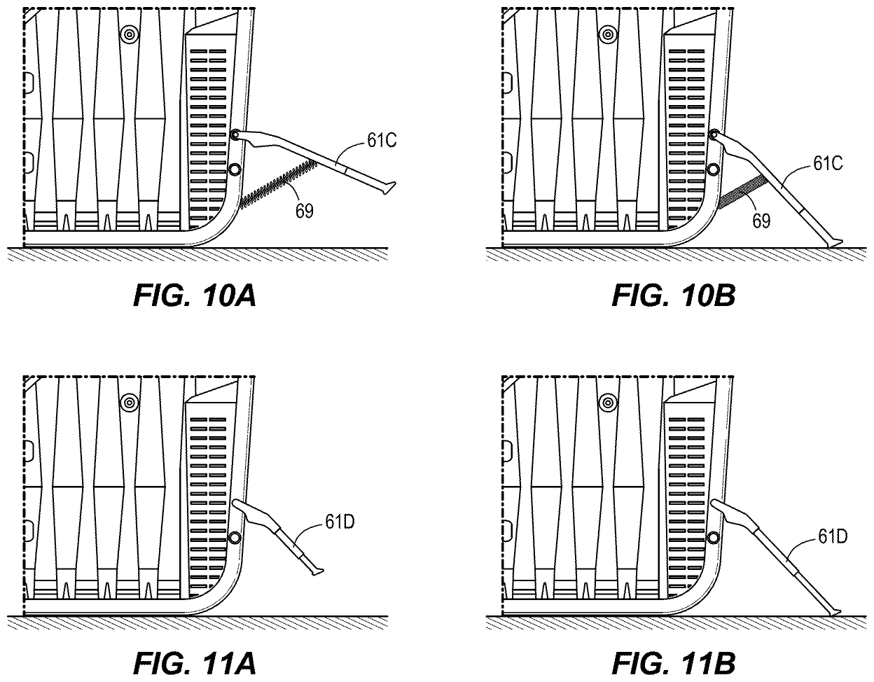

In another embodiment, shown in FIGS. 10A-10B, the power supply box 1 includes a kickstand 61C and a spring 69 attached to the kickstand 61C. The kickstand 61C is similar to the kickstand 61A. The spring 69 provides extra support to the kickstand 61C such that the power supply box 1 can be secured on steeper hills. The spring 69 may bias the kickstand 61C in the locked or unlocked position. Both the spring 69 and the kickstand 61C may be attached to the back or side of the power supply box 1. To move the kickstand 61C to the locked position, the kickstand 61C is pulled down until engages the ground. The spring 69 provides extra support to the kickstand 61C by helping the kickstand 61C stay in place.

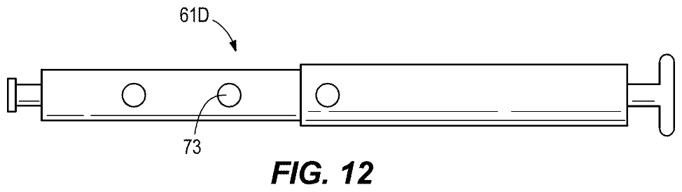

FIGS. 11A-12 show another embodiment of the power supply box 1. The power supply box 1 may include a telescoping kickstand 61D. The telescoping kickstand 61D may be outfitted with a plurality of detents 73 that allow the telescoping kickstand 61D to lock at a desired length. The ability to have different lengths allows the telescoping kickstand 61D to be used on a variety of slopes.

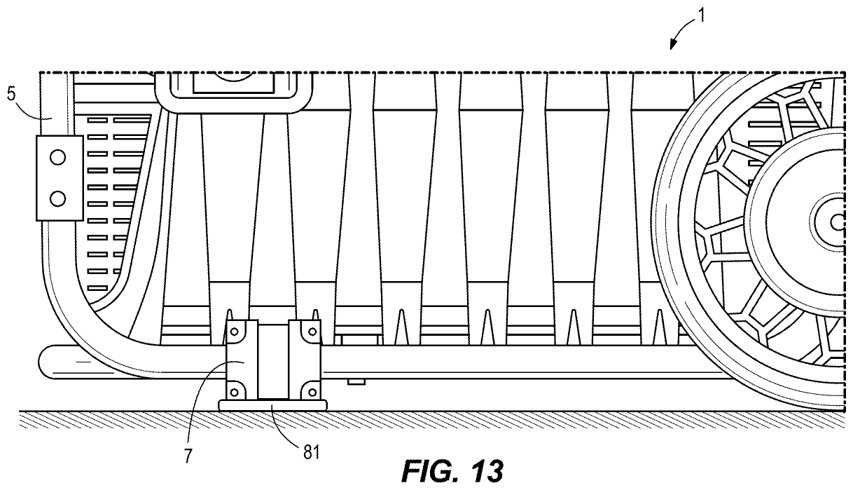

Turning to FIG. 13, another embodiment of the power supply box 1 is shown. The power supply box 1 may have a rubber pad 81 attached to one of the feet 7 located at the bottom of roll cage 5. The rubber pad 81 increases the friction coefficient required to move the power supply box 1, thus preventing the power supply box 1 from rolling away.

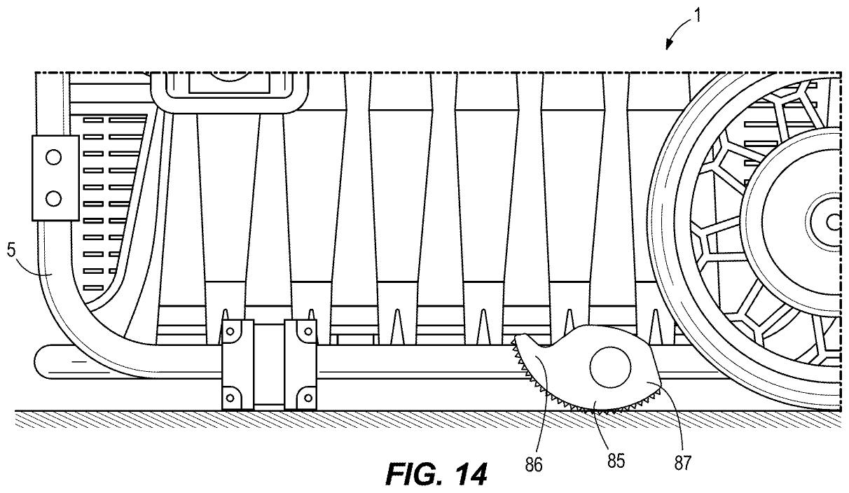

In another embodiment, shown in FIG. 14, the power supply box 1 includes a cam 85 disposed on the bottom of the roll cage 5. The cam 85 may be eccentrically, pivotably connected to the roll cage 5. The cam 85 has a first radial section 86 (e.g., a ground engagement member) and a second radial section 87. The first radial section 86 extends radially outward and the second radial section 87 extends in an opposite direction. The first radial section 86 is longer than the second radial section 87. The second radial section 87 is adjacent the wheels 9. When the power supply box 1 is being rolled, the cam 85 is in clearance and does not prevent the power supply box 1 from moving, and the first radial section 86 and the second radial section 87 are in an unengaged position When the power supply box 1 is placed on a flat surface, a portion of cam 85 makes contact with the ground. If the cam 85 shifts forward (e.g., in the direction opposite the wheels), the cam 85 pivots such that the first radial section 86 extends below the frame and contacts the ground (e.g., is in an engaged position) to prevent the power supply box 1 from rolling forward. If the cam 85 shifts backward (e.g., in the direction toward the wheels), the cam 85 pivots such that the second radial section 87 contacts the ground and prevents the power supply box 1 from rolling backward. The cam 85 increases the friction coefficient required to move the power supply box 1 thus preventing the power supply box 1 from rolling away.

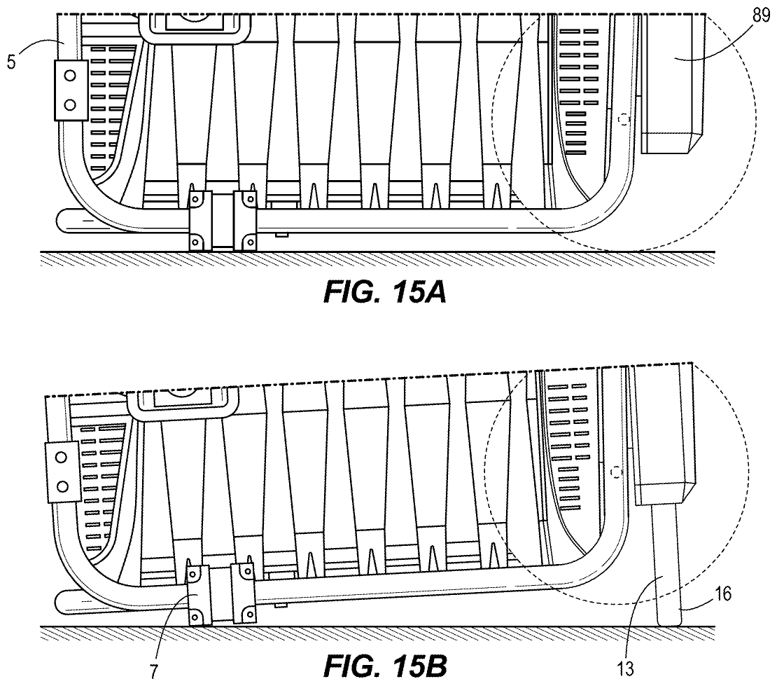

Turning to FIGS. 15A-15B, another embodiment of the power supply box 1 is shown. The power supply box 1 may include the retractable handle 13 and a handle housing 89 disposed on the housing 3. The handle housing 89 may have two openings. More specifically, the handle housing 89 may have an opening on the top of the handle housing 89 and an opening on the bottom of the handle housing 89. The retractable handle 13 may be slidable between a transport position, a storage position, and a locked position. In the transport position, the retractable handle 13 may be extended through the top opening of the handle housing 89 such that the user can easily grasp the handle 13. While the power supply box 1 is in the storage position (FIG. 15A), the retractable handle 13 may be almost fully disposed in the handle housing 89. In the locked position (15B), the retractable handle 13 may be pushed downward such that an end of the handle 13 opposite the user engagement portion 15 extends through the bottom opening of the handle housing 89 and engages the ground. In the locked position, the end of the handle 13 extends past the wheel 9. The locked position causes the wheel 9 to be lifted off the ground such that the wheel 9 is no longer in engagement with the support surface. The retractable handle 13 and the feet 7 provide the power supply box 1 with four secure points of contact with the ground, preventing the power supply box 1 from easily rolling.

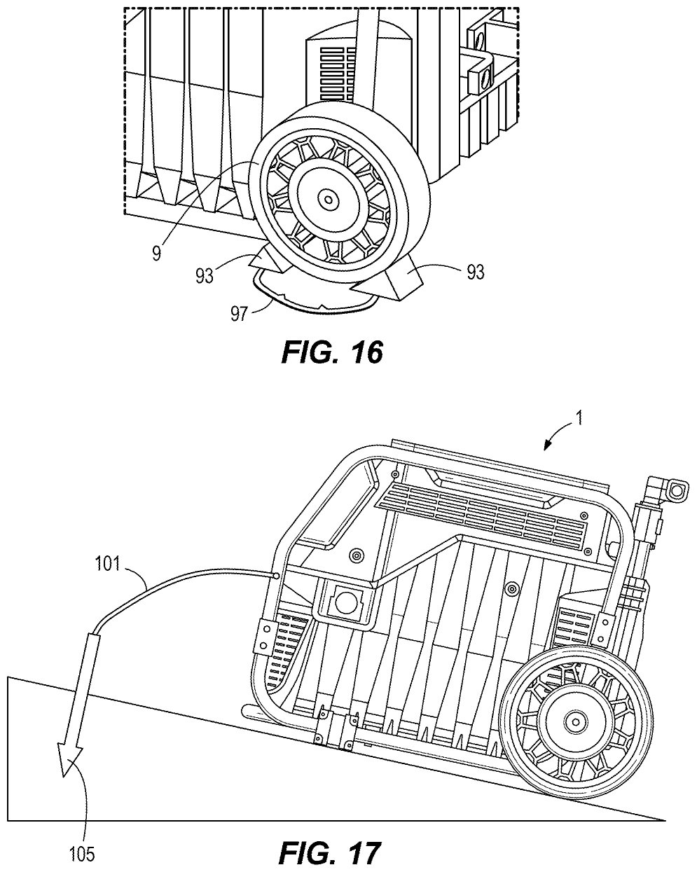

FIG. 16 shows yet another embodiment of the power supply box 1. The power supply box 1 may include two blockers 93 that are attached by a string 97. The user places the two blockers 93 on either side of the wheel 9. The two blockers 93 may be angled to allow them to be placed closer to the wheel 9. The two blockers 93 stops the wheel 9 from moving forward or backward by providing a physical obstacle.

Another embodiment of the power supply box 1 is shown in FIG. 17. The power supply box 1 may include a peg 105 that is attached to a tether 101. The tether 101 may be attached to the housing 3 of power supply box 1. The tether 101 and peg 105 may be able to be retracted and stored in the housing 3 of the power supply box 1 while not in use. To secure the power supply box 1, the user pushes and inserts the peg 105 into the ground (e.g., penetrates the ground). The peg 105 and tether 101 prevent the power supply box 1 from sliding beyond the length of the rope.

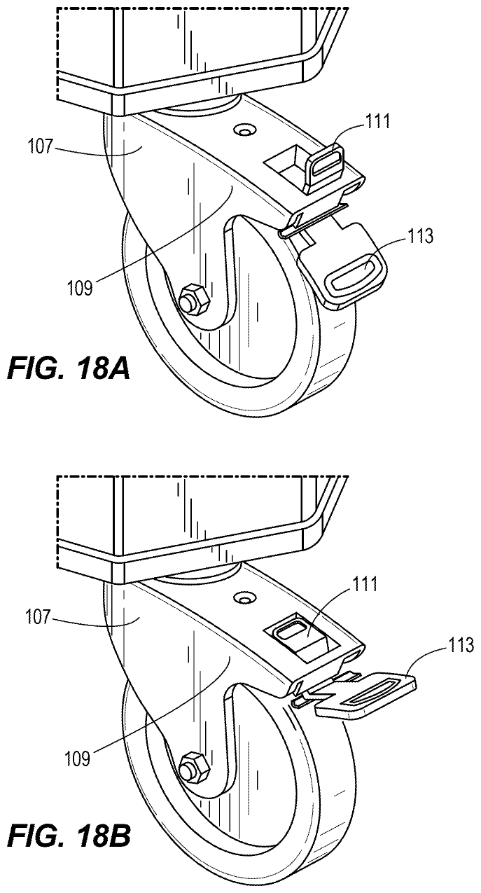

Turning to FIGS. 18A-18B, a footpad trigger 109 is shown. The footpad trigger 109 includes a wheel housing 107, a lever 111, and a stop 113 attached to the lever 111. In the locked position (18A) the stop 113 is engaged with the wheel 9 to prevent the wheel from rotating and the lever 111 is extended from the wheel housing 107. The footpad trigger is easily moved to unlocked position by pressing on the lever 111. In the unlocked position (FIG. 18B), the lever 111 is engaged with the wheel housing and the stop 113 extended from the wheel 9 such that it is not engaged with the wheel 0.

The footpad trigger 109 can be added to any of the embodiments to allow the user to easily activate the securing mechanism with their foot (via the lever 111 and the stop 113), instead of having the user lean down and activate the securing mechanism by hand.

In order to prevent the power supply box 1 from rotating, a securing member may be disposed on both sides of the power supply box 1. For example, the power supply box 1 may have a kickstand disposed on the left and right side of the power supply box 1 to prevent the power supply box 1 from rotating. This may be true for the embodiments shown in FIGS. 2-14 and 16-17.

Although the disclosure focuses on a securing member for a power supply box 1, illustrated in FIG. 1, one skilled in the art would recognize that the securing members can be used on a variety of other portable boxes with wheels (e.g., coolers, generators, toolboxes) to secure and prevent the portable boxes from rolling away or rotating.

In one independent aspect, a portable power source moveable over a support surface comprises a power supply, a frame at least partially surrounding the power supply, at least one wheel, and a clamping mechanism that moves from a first position to a second position. The clamping mechanism stops the wheel in the first position and allows the rotation of the wheel in the second position.

In some aspects, the clamping mechanism engages a portion of the wheel in the first position. The clamping mechanism engages the disk in the first position.

In some aspects, the portable power source further includes a disk coupled to an axle that rotates with the wheel.

In some aspects, the portable power source further includes an actuator configured to move the clamping mechanism into the first position and into the second position.

In some aspects, the portable power source further includes a spring biasing the clamping mechanism to one of the first position or the second position.

In some aspects, the actuator is a first actuator and the portable power source includes a second actuator.

In another independent aspect, a portable power source moveable over a support surface comprises a power supply, a frame at least partially surrounding the power supply, at least one wheel, and a handle. The handle has a user engagement portion and at least one upright member. The upright member is slidable relative to the frame. The upright member is slidable into a locking position. The locking position has an end of the upright member, opposite the user engagement portion, extending past the wheel to engage the support surface.

In some aspects, the end of the upright member extends beyond the wheel to engage the support surface such that the wheel is no longer in engagement with the support surface.

In some aspects, the portable power surface further comprises comprising a pair of stops coupled to the frame.

In some aspects, the handle is adjacent the wheel.

In some aspects, the handle is slidable into a transport position and a storage position.

In yet another independent aspect, a portable power source is moveable over a support surface. The portable power source includes a power supply, a frame at least partially surrounding the power supply, at least one wheel, a handle, and a ground engagement member is attached to the frame. The handle includes a user engagement portion and at least one upright member. The ground engagement member is configured to pivot between an engaged position and a disengaged position. The ground engagement member is extended from the frame to contact the support surface in the engaged position.

In some aspects, the frame includes a housing and a roll cage.

In some aspects the ground engagement member is a kickstand.

In some aspects, the portable power source includes a hinged locking lever attached to the frame and the kickstand.

In some aspects, the portable power source includes a spring attached to the frame and the kickstand.

In some aspects, the kickstand is configured to extend to more than one length.

In some aspects, the kickstand includes detents that locks the kickstand in a desired length.

In some aspects, the portable power source includes a cam having a first radial section and a second radial section. The first radial section extends radially outwards and the second radial section extends in an opposite direction. The first radial section is longer than the second radial section. The first radial section is the ground engagement member.

In some aspects, the second radial section is adjacent the wheel.

In another independent aspect, a portable power source is moveable over a support surface. The portable power source includes a power supply, a frame at least partially surrounding the power supply, at least one wheel, a tether coupled to the frame, and a peg coupled to the tether. The peg is configured to penetrate the support surface.

In some aspects, the tether and peg may be retracted into the frame while not in use.

In yet another independent aspect, a portable power source moveable over a support surface includes a power supply a frame at least partially surrounding the power supply, at least one wheel, and a kickstand attached to the frame. The kickstand extends from the frame to contact the support surface.

In another independent aspect, a portable power source moveable over a support surface comprises a power supply, a frame at least partially surrounding the power supply, at least one wheel defining a rotational axis, and a pin moveable in a direction parallel to the rotational axis of the wheel. The pin is configured to selectively engage the wheel.

In some aspects, the portable power source further includes a plate coupled to the frame. The plate includes at least two through holes each of which are configured to receive the pin.

In some aspects, the pin is slidably coupled to the plate.

In some aspects, the pin further includes a handle and a spring that biases the handle towards the plate.

In some aspects, the pin extends through the plate and the wheel to lock the wheel.

In yet another independent aspect, a portable power source moveable over a support surface comprises a power supply, a frame at least partially surrounding the power supply, at least one wheel defining a rotational axis, and a chock bar that is pivotable to engage an outer perimeter of the wheel.

In some aspects, the chock bar rotates in a plane that is perpendicular to the rotational axis of the wheel.

In some aspects, the chock bar rotates in a plane that is parallel to the rotational axis of the wheel.

In some aspects, the chock bar is translatable perpendicular to the plane.

Various features of the disclosure are set forth in the following claims.

What is claimed is:

1. A portable power source moveable over a support surface, the portable power source comprising:
a power supply;
a frame at least partially surrounding the power supply;
at least one wheel attached to the frame by an axle;
a handle coupled to the frame, the handle including a user engagement portion and at least one upright member; and
a clamp that moves from a clamped position to a release position, the clamp preventing rotation of the wheel in the clamped position, and the clamp allowing rotation of the wheel in the release position.

2. The portable power source of claim 1, wherein the clamp engages a portion of the wheel in the clamped position.

3. The portable power source of claim 1, further comprising a disk coupled to the axle, wherein the clamp engages the disk when the clamp is in the clamped position.

4. The portable power source of claim 1, further comprising an actuator coupled to the clamp, the actuator is configured to move the clamp into the clamped position and into the release position.

5. The portable power source of claim 4, further comprising a spring biasing the clamp to the release position.

6. The portable power source of claim 4, wherein the actuator is a first actuator and the portable power source further comprises a second actuator attached to the clamp.

7. A portable power source moveable over a support surface, the portable power source comprising:
a power supply;
a frame at least partially surrounding the power supply;
at least one wheel;
a handle including a user engagement portion and at least one upright member; and
a ground engagement member attached to the frame, the ground engagement member configured to pivot between an engaged position and a disengaged position, in the engaged position, the ground engagement member is extended from the frame to contact the support surface.

8. The portable power source of claim 7, wherein the frame includes a housing and a roll cage.

9. The portable power source of claim 7, wherein the ground engagement member includes a kickstand.

10. The portable power source of claim 9, further comprising a hinged locking lever attached to the frame and the kickstand.

11. The portable power source of claim 9, further comprising a spring attached to the frame and the kickstand.

12. The portable power source of claim 9, wherein the kickstand is configured to extend to more than one length.

13. The portable power source of claim 12, wherein the kickstand includes at least one detent that locks the kickstand in a desired length.

14. The portable power source of claim 7, wherein
the ground engagement member includes a cam having a first radial section and a second radial section,
the first radial section extends radially outwards and the second radial section extends radially outwards in a direction opposite that of the first radial section,
the first radial section is longer than the second radial section.

15. The portable power source of claim 14, wherein a distance between the second radial section and the wheel is less than a distance between the first radial section and the wheel.

16. A portable power source moveable over a support surface, the portable power source comprising:
a power supply;
a frame at least partially surrounding the power supply;
at least one wheel; and
a handle including a user engagement portion and at least one upright member, the upright member being translatably coupled to the frame, the upright member translatable into a locking position, the locking position including an end of the upright member, opposite of the user engagement portion, extending past the wheel to engage the support surface.

17. The portable power source of claim 16, wherein the end of the upright member extends beyond the wheel to engage the support surface such that the wheel is elevated off the support surface.

18. The portable power source of claim 16, further comprising a pair of stops coupled to the frame.

19. The portable power source of claim 16, wherein the upright member overlaps the wheel in a direction parallel to a rotational axis of the wheel.

20. The portable power source of claim 16, wherein the handle is further translatable into a transport position and a storage position.
